(19) United States
(12) Patent Application Publication
(10) Pub. No.: US 2003/0134707 A1
(43) Pub. Date: Jul. 17, 2003

(54) Continuously variable transmissions using magnetorheological fluid or oil shear and methods of and systems for using the same in a vehicle, in-wheel application

(76) Inventors: James H. Goldie, Lexington, MA (US); John R. Oleksy, Maynard, MA (US); Jerome E. Kiley, Boston, MA (US)

Correspondence Address: Dike, Bronstein, Roberts & Cushman, Intellectual Property Practice Group, Edwards & Angell, LLP, Post Office Box 9169, Boston, MA, 02209, US

(21) Appl. No.: 10/290,560

(22) Filed: Nov. 8, 2002

Related U.S. Application Data
(60) Provisional application No. 60/347,989, filed on Nov. 8, 2001.
(60) Provisional application No. 60/361,453, filed on Mar. 4, 2002.

(51) Int. Cl. F16H 3/76

(52) U.S. Cl. 475/149

(57) ABSTRACT

Continuously variable speed ratio transmissions (CVT) for an in-wheel application use one or more magnetorheological (MR) or oil-shear clutch assemblies, each of which can have a unique speed ratio, to transmit torque between an input shaft and an output shaft. The clutch assemblies comprise an input drive element, input idler assemblies, a number of clutch assemblies output idler assemblies, and an output shaft assembly. Preferably, the CVT can be structured and arranged to occupy a volume between about 10- and 11-inches in diameter and between about 4 and 5 inches in axial length. The MR clutch assembly includes a rotateable input cylinder and a rotateable output cylinder that are coaxial about a stationary shaft. The input cylinder and output cylinder are separated by a gap that is filled with an MR fluid. A multitude of coil windings are disposed on the stator of each of the MR clutch assemblies. When current flows through the coil windings, a magnetic flux field is produced in the MR fluid. The MR fluid densifies, transferring input cylinder torque to the output cylinder by shear. A control unit can control current to the coil windings so that only clutch assemblies having the desired speed ratio are actuated. Alternatively, a CVT comprises a number of oil-shear clutch assemblies, each of which can have unique speed ratios, to transmit torque between a rotateable clutch cylinder and a rotateable drive cup and hub assembly through shear in the oil and/or through direct contact between the two cups. A control unit can control an external pressure that can be added to one or more of the oil-shear clutches to increase of decrease the separation distance between the two cups to provide the desired speed ratio. A CVT with a moveable magnetic flux producing device to produce a localized magnetic flux field in MR fluid that is disposed in the gap between a rotatable internal drive element and a rotateable external drive element. The speed ratios associated with various positions device differ, providing an infinite variable speed ratio transmission.

### CROSS-REFERENCE TO RELATED APPLICATIONS

This application claims priority from provisional application No. 60/347,989 filed by the same inventors on Nov. 8, 2001 and 60/361,453 filed on Mar. 4, 2002.

### STATEMENT REGARDING FEDERALLY-SPONSORED RESEARCH

This invention was made with Government support under contract number DAAD 17-02-C-0006 with the United States Army Research Laboratory, Vehicle Technology Directorate. The Government has rights in the invention.

### FIELD OF INVENTION

The present invention relates to devices, methods, and systems for providing a vehicle, in-wheel transmission and, more particularly, to devices, methods, and systems for providing a continuously variable speed ratio transmission using a magnetorheological fluid in conjunction with a movable electromagnetic coil, moveable permanent magnet or other means to produce a magnetic field flux or using oil shear clutching technology.

### BACKGROUND OF THE INVENTION

Conventional motor vehicles, especially those equipped with an automatic transmission, typically transmit power from a piston-driven engine, i.e., driving energy or torque, to the drive train, i.e., the transmission, using a torque converter. Typical torque converters transfer torque in either of two phases. One of the two phases typically occurs when the transmission clutch is engaged, which produces a direct coupling between the input and the output shafts. In this instance, gear teeth transfer torque, e.g., by friction, from the gears connected to an input shaft to the gears connected to an output shaft. Characteristically, output torque is greater than input torque as a result of a multiplying effect, i.e., the speed ratio. In the second phase, no such torque multiplication occurs.

Conventional, piston-driven engines, however, are bulky, relatively large, and relatively heavy. Furthermore, torque converter clutches of conventional, piston-driven engines are characteristically inefficient as much of the deliverable power is lost before the power ever reaches and turns the vehicle wheels. Indeed, limitations of such gear-driven transmissions include a predetermined number of fixed drive ratios; heat and associated problems caused by friction; and wear and tear caused by gear meshing.

In-wheel propulsion of motor vehicles has been proposed for use in a myriad of applications, e.g., hybrid electric vehicles. Typically, in-wheel propulsion devices and systems include transmissions, which are structured and arranged to be disposable in close proximity of a vehicle wheel. Optimally, the design of such a transmission must satisfy torque, speed, and efficiency requirements. More important, however, such a transmission must be designed to occupy a relatively small, non-obtrusive volume.

Others skilled in the art have taken many approaches for realizing an in-wheel transmission as an alternative to conventional transmissions. These approaches include axial movement of a belt relative to a conical surface over which it passes, adjustment of the position of contacting conical surfaces relative to one another, adjustment of the radius at which a roller contacts the axial face of a rotating disk, and fluid-based concepts that are akin to a torque converter.

To address shortcomings associated with the prior art, some have proposed continuously variable transmissions (CVT) that use a magnetorheological fluid that is confined in a space, or a gap, between a pair of opposing plates or, alternatively, between an input and an output shaft, to transfer torque. Magnetorheological fluid comprises a suspension of solid particles, e.g., finely powered ferrous metal or ferrous alloy, in a selected fluid, e.g., water, silicone, mineral oil, base oil, and the like, that is responsive to an electromagnetic field. In one example, the opposing plates, e.g., an input and an output plate, are highly magnetically permeable so that if a magnetic field is applied to the gap between the plates at any location, the generated flux causes the solid particles in the magnetorheological fluid to form chain-like structures at that location.

Shear force and, hence, torque can be transferred, e.g., from one opposing, e.g., input, plate or shaft to the other opposing, e.g., output, plate or shaft, by the response, i.e., alignment, of the suspended solid particles to the applied magnetic field. As flux density increases, the yield shear stress of the magnetorheological fluid also increases due to the density of the suspended solid particles. Accordingly, the shear stress in the fluid approaches the fluid's yield stress, i.e., the stress at which the elastic solid yields to become viscous, which allows for the transmission of motion between the two plates or shafts.

U.S. Pat. No. 5,823,309 to Gopalswamy, et al. discloses an automatic transmission clutch using magnetorheological fluids for controlling torque transmission. The Gopalswamy magnetorheological clutch's contribution to the prior art, however, only includes a series of radially extending cooling fins and a thermal expansion chamber to dissipate heat generated by the clutch.

U.S. Pat. No. 6,089,115 to Yoshioka discloses an angular transmission using magnetorheological fluid to transmit torque between two shafts, i.e., an input shaft and an output shaft, to provide infinite variable drive ratios. The Yoshioka device includes a pair of hollow, conically-shaped heads that are attached to an input and an output shaft, which shafts are not aligned in the same axis. Magnetorheological fluid occupies the gap between the hollow heads. Furthermore, electromagnetic coils are disposed at fixed locations inside the hollow, conically-shaped heads to generate a magnetic field. However, the Yoshioka device merely provides a means of controlling the slip ratio between the input and output shafts by controlling the yield shear stress of the magnetorheological fluid, which is accomplished by varying the strength of the magnetic field. Since this device as described relies on slip, the upper bound on its efficiency is the ratio of the input speed to the output speed, limiting its practical use to very low power applications or speed reductions very close to unity.

A published Japanese laid-open abstract to the same inventor (JP 2000-065094), discloses an infinite variable ratio transmission having a series of disks and plates, whereby magnetoelectric coils generate magnetic fields that change the yield shear stress of the magnetorheological fluid. As with the U.S. patent described above, the strength of the magnetic field is controlled in order to control the slip ratio between the disks of the input shaft and the plates of the output shaft. Here again, this invention by Yoshioka merely controls the slip ratio by controlling the fluid yield shear stress, imposing the same limitations on its practical use as for the previous device.

For a particular application, existing approaches for continuously variable transmissions generally are not suitable for application to an in-the-wheel motor, i.e., an “in-wheel application”. First, the continuously variable transmission must be capable of handling input speeds as high as about 6000 rpm. Secondly, it must achieve efficiencies suitable for transmission of mechanical power up to 50 hp to the wheel. Furthermore, in order to create a motor-CVT assembly that is appropriate for in-wheel application, the continuously variable transmission must be confined to a relatively small volume in which the axial length is small compared with its diameter, i.e., about 3 to 5 inches in axial length for about a 10- to 11-inch diameter.

### SUMMARY OF THE INVENTION

In one embodiment, the present invention provides a CVT that utilizes magnetorheological (MR) fluids to transmit the shear force between coupled transmission components. Preferably, this embodiment of the present invention includes one or more inner planetary elements and an outer ring element that “engage” one another along conical or cylindrical surfaces. Such “engagement” occurs as shear force is transmitted from one surface, e.g., the inner planetary element, to the other surface, e.g., the outer ring element, through an MR fluid that is confined in a space or gap therebetween; rather than by tooth meshing or by friction. In the area influenced by a magnetic field, MR fluids can sustain shear stresses as high as about 70 kPa (≈10 psi). In the absence of a magnetic field, however, the shear stress transmitted by the MR fluid is limited to that corresponding to the viscosity of the fluid, e.g., silicone, mineral oil, base oil, and the like. Thus, unlike the prior art, which has addressed the problem by varying the strength of the magnetic field at a fixed location to affect the slip ratio between the input and output plates or shafts, the present invention selectively varies the axial and/or radial position of shear force transmission by adjusting the location at which the magnetic field is applied. Since the ratio of the radii of the two conical or cylindrical surfaces (R₂/R₁) varies with axial and/or radial position, the effective speed reduction can be adjusted simply by controlling the axial and/or radial location of a permanent magnet or electromagnet, e.g., coil.

In a particular embodiment of the present invention, the CVT is designed to fit within a space that is less than about 10-1/2 inches in diameter and less than about 4.5 inches in depth, e.g., to fit in a motor vehicle wheel. A compact, efficient CVT offers reduced energy consumption, reduced motor torque/speed demands, and, ultimately, reduced cost in conventional, electric, and hybrid electric cars and vehicles. It also allows a practical means for adjusting main rotor speed on helicopters, a useful capability during forward flight. A high power CVT can make possible low cost variable speed drives for fans, pumps, blowers, and compressors driven by fixed-frequency AC induction motors. Furthermore, in automotive, aerospace, and HVAC system markets, a viable CVT provides reduced weight, better energy efficiency, greater operational range, and reduced acquisition cost.

Accordingly, one embodiment of the present invention includes a continuously variable speed ratio transmission for providing input torque to an output shaft, the transmission comprising:

an internal drive element movable about an axis, the internal drive elements further comprising one or more planets, said internal drive element being in communication with a device for providing said input torque;

an external drive element movable about an axis, said external drive element being in communication with the output shaft to provide torque to said output shaft,

wherein said internal drive element and said external drive element are structured and arranged to provide a gap therebetween and, further, so that their axes are substantially parallel;

magnetorheological fluid that is disposed in said gap between said internal drive element and said external drive element; and

a magnetic flux producing device, wherein said magnetic flux producing device is moveable with respect to said axes.

In another aspect of the first embodiment, one or more planets includes a first plurality of fins structured and arranged thereon and the external drive element includes a second plurality of fins structured and arranged thereon, wherein the second plurality of fins is disposed relative to the first plurality of fins to produce the gap in which the magentorheological fluid is disposed.

In another aspect of the first embodiment, the magnetic flux producing device is movable in at least one of an axial direction and a radial direction with respect to the axes.

In still another aspect of the first embodiment, torque is transferred from the device for providing input torque to the output shaft by positioning the moveable magnetic flux producing device at a discrete location and actuating the magnetorheological fluid in proximity of the moveable magnetic flux producing device by passing current through the moveable magnetic flux producing device so as to produce a magnetic flux field. The magnetic flux filed increases the density of the magnetorheological fluid by aligning the ferrous particles in the solution which densifies magnetorheological fluid, providing an activated shear region through which torque from the device for providing input torque is transferable to the output shaft.

In a further aspect of the first embodiment, the present invention includes a system for providing continuous variable transmission for an in-wheel motor vehicle, wherein the system comprises:

an in-wheel motor that provides an input speed and an input torque;

a continuous variable speed ratio transmission comprising a magnetorheological fluid and a moveable magnetic flux producing device, wherein said continuous variable speed ratio transmission transfers the input torque from the in-wheel motor through said magnetorheological fluid to an output shaft to drive a motor vehicle wheel by shear; and

a continuous variable transmission control unit that provides a control current to position the moveable magnetic flux producing device at a desired location, wherein said moveable magnetic flux producing device provides a magnetic flux field in the magnetorheological fluid at the desired location that provides a shear region in said magnetorheological fluid at said desired location through which the input torque is transferred; and, further comprises

an internal drive element movable about an axis, the internal drive elements further comprising one or more planets, said internal drive element being in communication with a device for providing said input torque; and

an external drive element movable about an axis, said external drive element being in communication with the output shaft to provide torque to said output shaft,

wherein said internal drive element and said external drive element are structured and arranged to provide a gap therebetween and, further, so that their axes are substantially parallel.

In a second embodiment, the present invention includes a continuously variable speed ratio transmission for providing input torque to an output shaft, the transmission comprising:

an input drive element further comprising an input shaft, said input drive element being in communication with a device for providing said input torque;

a first plurality of idler assemblies that are in communication with the input shaft of the input drive element, whereby input torque provided by said input shaft is transmitted to each of said first plurality of idler assemblies;

one or more magnetorheological clutch assemblies, each of the one or more magnetorheological clutch assemblies having a speed ration and further comprising:

an input cylinder that is rotatable about a stationary shaft;

a clutch input gear, an outer periphery of which is in communication with an outer periphery of one of the first plurality of idler assemblies and the input cylinder so that the clutch input gear, one of the first plurality of idler assemblies and said input cylinder can rotate synchronously; and

a output cylinder which is in communication with an output gear so that the output cylinder and output gear can rotate synchronously, wherein the output cylinder is coaxial with the input cylinder and separated therefrom by a fluid filled-gap;

a second plurality of idler assemblies, wherein each of said second plurality of idler assemblies is in communication with a discrete output gear of the output cylinder of one of the one or more magnetorheological clutch assemblies, whereby torque transmitted to the output gear of said one or more magnetorheological clutch assemblies is further transmitted to each of said second plurality of idler assemblies; and

an output shaft assembly further comprising:

an output shaft;

an output gear, an outer periphery of which is in communication with each of the second plurality of idler assemblies and the output shaft,

whereby any torque transmitted to said second plurality of idler assemblies is further transmitted to said output shaft assembly output gear and then to the output shaft of the output shaft assembly.

In another aspect of the second embodiment, the transmission further comprises:

a housing assembly, the housing assembly further comprising:

a housing body, wherein the housing body is structured and arranged to accommodate the one or more magnetorheological clutch assemblies;

a first housing cover having an opening, wherein the input drive element is structured and arranged so that the said input drive element is releasably attached to an out surface of the first housing cover and the input shaft of said input drive element is disposed through the opening; and

a second housing cover having an opening, wherein the output shaft assembly is structured and arranged so that the output shaft assembly is releasably attached to an outer surface of the second housing cover; the output gear of said output shaft assembly is disposed through the opening.

In yet another aspect of the second embodiment, each of the one or more magnetorheological clutch assemblies further comprises one or more current-carrying coil windings through which current can be transmitted to induce a magnetic flux field in a magnetorheoloigcal fluid disposed in the fluid-filled gap and the transmission can provide a desired speed ratio by transmitting current to one or more magnetorheological clutch assemblies that have the desired speed ratio.

Preferably, the speed ratio of each of the one or more magnetorheological clutch assemblies is unique. Alternatively, the one or more magnetorheological clutch assemblies comprises pairs of diametrically opposed clutch assemblies that have the same speed ratio. In a preferred embodiment, the one or more magnetorheological clutch assemblies comprises six clutch assemblies.

In a third embodiment, the present invention comprises a method of providing a continuously variable speed ratio in a transmission, the transmission, the method comprises the steps of:

providing an outer ring gear;

providing at least one inner rotating gear that is disposed inside the outer ring gear;

structuring and arranging the at least one inner rotating gear and the outer ring gear so they are aligned in parallel axes and to provide a space or gap therebetween;

introducing a magentorheological fluid into said space or gap between said at least one inner rotating gear and said outer ring gear;

providing a moveable magnetic flux producing device to induce a magnetic flux field at a desired location within said space or gap in order to activate the magnetorheological fluid at the desired location; and

transferring torque from the at least one inner rotating gear to the outer ring gear as shear stress in the magnetorheological fluid in the desired location to provide a desired speed ratio.

According to one aspect of the third embodiment, the step of providing a moveable magnetic flux producing device comprises providing a moveable magnetic flux producing device that translates in at least one of a substantially axial direction and a substantially radial direction with respect to the parallel axes.

According to another aspect of the third embodiment, the step of transferring torque from said at least one inner rotating gear to said outer ring gear is transferred through the magnetorheological fluid that is disposed between a first plurality of fins disposed on said at least one inner rotating gear and a second plurality of fins disposed on said outer ring gear.

According to still another aspect of the third embodiment, the method further comprises the step of controlling the desired speed ratio by controlling current intensity to the moveable magnetic device.

In a fourth embodiment, the present invention comprises a continuously variable speed ratio transmission for providing input torque to an output shaft, the transmission comprising:

an input drive element further comprising an input shaft, said input drive element being in communication with a device for providing said input torque;

a first plurality of idler assemblies that are in communication with the input shaft of the input drive element, whereby input torque provided by said input shaft is transmitted to each of said first plurality of idler assemblies;

one or more clutch assemblies, each of said one or more clutch assemblies having a speed ratio, wherein each of said one or more clutch assemblies comprises:

an input clutch gear of the same diameter, and

an output clutch gear having a diameter that affects the speed ratio,

whereby any torque transmitted to the input clutch gear of each of said one or more clutch assemblies by said first plurality of idler assemblies is further transmitted to the output clutch gear of each of said one or more clutch assemblies;

a second plurality of idler assemblies, wherein each of said second plurality of idler assemblies is in communication with the output clutch gear of said one or more clutch assemblies, whereby any torque transmitted to each output gear of said one or more clutch assemblies by said first plurality of idler assemblies is further transmitted to each of said second plurality of idler assemblies; and

an output shaft assembly further comprising:

an output gear that is in communication with each of said second plurality of idler assemblies, and

an output shaft that is in communication with said output shaft assembly output gear,

whereby any torque transmitted to the second plurality of idler assemblies is further transmitted to said output shaft assembly output gear and then to the output shaft of the output shaft assembly.

Preferably, the clutch assemblies are oil shear-type clutch assemblies.

In one aspect of the fourth embodiment, the transmission further comprises a housing assembly, the housing assembly further comprising:

a housing body, wherein the housing body is structured and arranged to accommodate the one or more clutch assemblies;

a first housing cover having an opening, wherein the input drive element is structured and arranged so that the said input drive element is releasably attached to an out surface of the first housing cover and the input shaft of said input drive element is disposed through the opening; and

a second housing cover having an opening and a plurality of inlet tube openings, wherein the output shaft assembly is structured and arranged so that the output shaft assembly is releasably attached to an outer surface of the second housing cover; the output gear of said output shaft assembly is disposed through the opening; and each inlet tube of said plurality of inlet tubes is in communication with a clutch inlet port on each of said one or more clutch assemblies for the purpose of controlling the speed ratio of the transmission.

In yet another aspect of the fourth embodiment of the present invention, the one or more clutch assemblies further comprises a clutch inlet tube for actuating one or more of said one or more clutch assemblies to provide a desired speed ratio to the output shaft.

In still another aspect of the fourth embodiment of the present invention, the diameter of the output clutch gear of at least two diametrically opposed clutch assemblies is the same. In a preferred embodiment, the one or more clutch assemblies comprises six clutch assemblies.

In a particular embodiment of the present invention, the CVT is designed to fit within a space that is less than about 10-1/2 inches in diameter and less than about 4.5 inches in depth, e.g., to fit in a motor vehicle wheel.

A compact, efficient CVT offers reduced energy consumption, reduced motor torque/speed demands, and, ultimately, reduced cost in conventional, electric, and hybrid electric cars and vehicles. It also allows a practical means for adjusting main rotor speed on helicopters, a useful capability during forward flight. A high power CVT can make possible low cost variable speed drives for fans, pumps, blowers, and compressors driven by fixed-frequency AC induction motors. Furthermore, in automotive, aerospace, and HVAC system markets, a viable CVT provides reduced weight, better energy efficiency, greater operational range, and reduced acquisition cost.

In a fifth embodiment, the present invention comprises a system for providing continuous variable transmission for an in-wheel motor vehicle, wherein the system comprises:

an in-wheel motor that provides an input speed and an input torque;

a continuous variable speed ratio transmission comprising one or more oil shear-type clutch assemblies, wherein each of the one or more oil shear-type clutch assemblies has a speed ratio; and

a continuous variable transmission control unit that provides external pressure to actuate one or more of the one or more oil shear-type clutch assemblies to provide a desired speed ratio, whereby actuation can be effected by applying said external pressure to one or more of said one or more oil shear-type clutch assemblies that have the desired speed ratio.

### BRIEF DESCRIPTION OF THE DRAWING

For a fuller understanding of the present invention, reference is made to the following detailed description taken in conjunction with the accompanying figures wherein like reference characters denote corresponding parts throughout the several views and wherein:

FIG. 1 shows a diagrammatic view of one embodiment of a CVT;

FIG. 2 shows a diagrammatic view of an embodiment of a conical CVT with fins;

FIG. 3 shows a diagrammatic view of an embodiment of a cylindrical CVT with fins;

FIG. 4 shows a diagrammatic of an epicyclic topology model of planetary motion;

FIG. 5 shows a diagrammatic of a hypocyclic topology model of planetary motion;

FIG. 6 shows a diagrammatic of the velocity vectors for an epicyclical and hypocyclic topology models;

FIG. 7 shows a block diagram of an embodiment of an in-wheel CVT system;

FIG. 8 shows an embodiment of a synchronous point and active area for an epicyclical topology model;

FIG. 9A shows a diagrammatic of an illustrative embodiment of a CVT with multiple gear trains;

FIG. 9B shows a cross-sectional view of section A-A taken from FIG. 9A;

FIG. 10A shows a diagrammatic of an illustrative embodiment of a planet assembly clutch for a multiple gear train CVT;

FIG. 10B shows a cross-sectional view of section A-A taken from FIG. 10A;

FIG. 11A shows a schematic view of an embodiment of the input side of an in-wheel CVT system with multiple oil shear clutch assemblies;

FIG. 11B shows a schematic view of an embodiment of the output side of an in-wheel CVT system with multiple oil shear clutch assemblies;

FIG. 12A shows an exploded view of an embodiment of a clutch assembly;

FIG. 12B shows a schematic view of an embodiment of a clutch assembly; and

FIG. 13 shows an exploded view of an oil shear clutch-type CVT system.

### DETAILED DESCRIPTION OF THE INVENTION INCLUDING THE PREFERRED EMBODIMENTS THEREOF

A first embodiment of the present invention will be described referring to FIG. 1. FIG. 1 shows a diagrammatic view of an embodiment of a continuous variable speed ratio transmission (CVT) 10. Preferably, the CVT 10 comprises an outer ring element 12 that can communicate with and drive, i.e., deliver torque to, an output shaft 18, at least one inner ring, or planet, 14 that can communicate with and be driven by an input shaft 16, and a moveable magnetic device 15 for inducing a magnetic flux field 19 at a precise location, i.e., the activated shear region 11. The outer ring element 12 and at least one planet 14 are structured and arranged to create a space or gap 13, in which an MR fluid (not shown) is disposed.

The input shaft 16 having or communicating with an input gear 17 drives, i.e., delivers torque to, the planet(s) 14. This driving energy, in turn, is transferred to the outer ring gear 12 through the activated MR fluid in the gap 13, i.e., the activated shear region 11 that is provided by the response of the solid particles in the MR fluid to the magnetic flux field 19. The moveable magnetic device 15, e.g., a permanent magnet, electromagnet, induction coil, and the like, can be moved axially and/or radially with respect to the axes of the input and output shafts 16 and 18. As a result, the magnetic flux field 19 induced by the moveable magnetic device 15 provides an activated MR, or shear, region 11 in the gap 13 at any desired location. The activated shear region 11 is simply the area in which a flux field 19 is the greatest and shear transfer occurs. In this manner, those skilled in the art can provide practically any gear ratio.

The gear, or speed, ratio SR of the CVT is defined as the ratio of the radius R₂ of the outer gear ring 12 measured at the activated shear region 11 with respect to the radius R₁ of the planet(s) 14 also measured at the activated shear region. That is to say that SR=R₂/R₁ By providing a movable magnetic device 15 to induce a magnetic flux field, the speed ratio SR can be varied continuously to provide virtually any gear ratio.

The functioning of the MR fluid in the activated shear region 11 will now be described. The effects of an MR fluid can be modeled with reasonable accuracy. Indeed, the magnitude of the shear stress, τ, in a fluid can be modeled as a Bingham solid. Thus,

$$τ = \{ \begin{matrix}G γ , & τ < {τ}_{y} \\ {τ}_{y} + η γ \& , & τ \geq {τ}_{y}\end{matrix} \qquad ( 1 )$$

where G is the shear modulus of the active MR fluid as it acts as an elastic solid, τ_{y} is the stress at which the elastic solid yields and becomes viscous, γ is the elastic shear strain, [symbol] is the viscous shear rate, and η is a proportionality constant relating shear stress and viscous shear rate.

Further, two eccentric disks in shear contact can be modeled, further, using the equation:

τ=τ_{y}+βVᵣₑₗ (2)

where Vᵣₑₗ is the magnitude of the relative velocity vector at any location between the two disks and β is a proportionality constant that varies between about 0.069 and about 0.69 kPa/(m/s) or about 2.54×10⁻⁴ to about 2.54×10⁻³ psi/(in/s). The elastic term of equation (1) can be neglected because there is relative velocity everywhere except at an infinitesimal point. In most cases, the second term of the right-hand side of equation (2) also can be discounted because β usually is relatively low and, further, because in the activated shear region 11, i.e., region over which field is applied to the MR fluid, relative velocities, typically, are relatively small. Hence, the second term and its effect on shear stress are negligible.

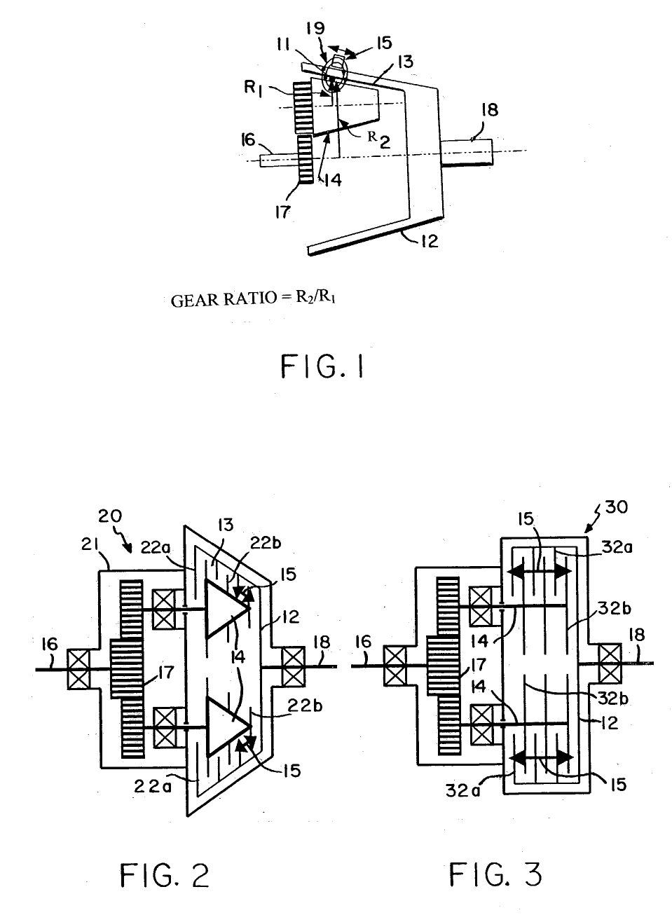

MR fluid, however, by itself is not capable of achieving comparable shear stress as gear teeth of a conventional transmission, especially at 50 hp. One solution to this is increasing the available surface area of the outer ring gear 12 and the planet(s) 14 to increase the activated shear region 11. Accordingly, in another embodiment, multiple interacting plates or fins, which function much like multiple-plate friction clutches, can be added to the planet(s) 14 and to the outer ring gear 12 to increase the shear area. FIGS. 2 and 3 show diagrammatic views of two embodiments of CVT assemblies having plate and fin configurations.

FIG. 2 shows an illustrative embodiment of a substantially conical CVT 20 having a substantially conical planet 14 and substantially conical outer ring gear 12 similar to that shown in FIG. 1. FIG. 2 further includes a housing 21 that encloses the entire device 20. Elements described previously in the discussion above are the same for this embodiment and will not be described further. This embodiment preferably includes a plurality of interacting plates or fins 22a and 22b that are structured and arranged on the outer gear ring 12 and the planet(s) 14, respectively. The plates or fins of the outer ring gear 22a are structured and arranged so as not to interfere with the free travel of the plates or fins of the planet(s) 22b. As the planet(s) 14 rotate or orbit, shear stress is transferred from the plates or fins of the planet(s) 22b to the plates of fins of the outer ring gear 22a by the MR fluid that is disposed in the space or gaps 13 between the plates or fins 22a and 22b. The moveable magnetic device 15 (shown as a bidirectional arrow) illustrates that the magnetic device 15 and the magnetic flux field 19 can be moved generally axially to control the speed reduction ratio, which is accomplished by positioning the magnetic device 15 at a location to provide that desired speed reduction ratio.

Preferably the spacing, i.e., the axial distance, between adjacent plates or fins 22a on the outer ring gear 12 and the spacing between adjacent plates or fins 22b on the planet(s) 14 is uniform. More preferably, the distance of the space or gap 13 between plates and fins 22b on the planet(s) 14 and adjacent plates or fins 22a on the outer ring gear 12 is uniform.

However, the present invention is not to be construed as being so limited. In a separate embodiment, the distance between adjacent plates and fins 22a and 22b and the distance of the space or gap 13 between plates and fins 22b of the planet(s) 14 and adjacent plates and fins 22a of the outer ring gear 12 can vary. For example, adjacent plates or fins 22b near the base of the conical planet 14 can be disposed closer together and/or separated by a shorter distance in the space or gap 13 between the planet plates or fins 22b and adjacent outer ring gear plates or fins 22a; and, alternatively, adjacent plates or fins 22b near the top of the conical planet 14 can be disposed further apart from one another and/or separated by a longer distance in the space or gap 13 between the planet plates or fins 22b and the outer ring gear plates or fins 22a. Accordingly, if a relatively higher speed ratio is desired, then the magnetic device 15 can be located more in proximity to the base of the conical planet(s) 14 and if a relatively lower speed ratio is desired, then the magnetic device 15 can be located more in proximity to the top of the conical planet(s) 14.

FIG. 3 shows an illustrative embodiment of a substantially cylindrical CVT 30 having substantially cylindrical planets 14 and a substantially cylindrical outer ring gear 12, which is the best mode of practicing the present invention. Elements described previously are the same and will not be described further. This embodiment preferably also includes a plurality of interacting plates or fins 32a and 32b that are structured and arranged on the outer gear ring 12 and the planet(s) 14, respectively. The plates or fins 32a of the outer ring gear 12 are structured and arranged so as not to interfere with the free travel of the plates or fins 32b of the planet(s) 14. As the planet(s) 14 rotate or orbit, shear stress is transferred from the plates or fins 32b of the planet(s) 14 to the plates of fins 32a of the outer ring gear 12 by the MR fluid that is disposed in the space or gaps 13 between the plates or fins 32a and 32b. The moveable magnetic device 15 (shown as a bi-directional arrow) illustrates that the magnetic device 15 and the magnetic flux field 19 can be moved generally radially to control the speed reduction ratio, which is accomplished by positioning the magnetic device (not shown) at a location to provide that desired speed reduction ratio.

Preferably the spacing, i.e., the axial distance, between adjacent plates or fins 32a on the outer ring gear 12 and the spacing between adjacent plates or fins 32b on the planet(s) 14 is uniform. More preferably, the distance of the space or gap 13 between plates and fins 32b on the planet(s) 14 and adjacent plates or fins 32a on the outer ring gear 12 is uniform. However, the present invention is not to be construed as being so limited.

In a separate embodiment, however, the distance between adjacent plates and fins 32a and 32b and the distance of the space or gap 13 between plates and fins 32b of the planet(s) 14 and those 32a of the outer ring gear 12 can vary. For example, the plates or fins 32b near the base of the cylindrical planet 14 can be disposed closer together and/or separated by a shorter distance in the space or gap 13 between the planet plates or fins 32b and the outer ring gear plates or fins 32a; and, alternatively, the plates or fins 32b near the top of the cylindrical planet 14 can be further apart from one another and/or separated by a longer distance in the space or gap 13 between the planet plates or fins 32b and the outer ring gear plates or fins 32a. Accordingly, if a relatively higher speed ratio is desired, then the magnetic device 15 can be located more in proximity to the base of the cylindrical planet(s) 14 and if a relatively lower speed ratio is desired, then the magnetic device 15 can be located more in proximity to the top of the cylindrical planet(s) 14.

Control of the speed reduction ratio is greatly improved when the location of the magnetic device 15 is adjusted radially along finned, cylindrical planets 14 rather than adjusted axially along finned, conical planets 14 because all fins 32a and 32b of the cylindrical planets 14 develop a shear stress region 11, whereas only a limited number of fins 22a and 22b of the latter develop a shear stress region 11. The power transmission capability of the CVT is increased accordingly.

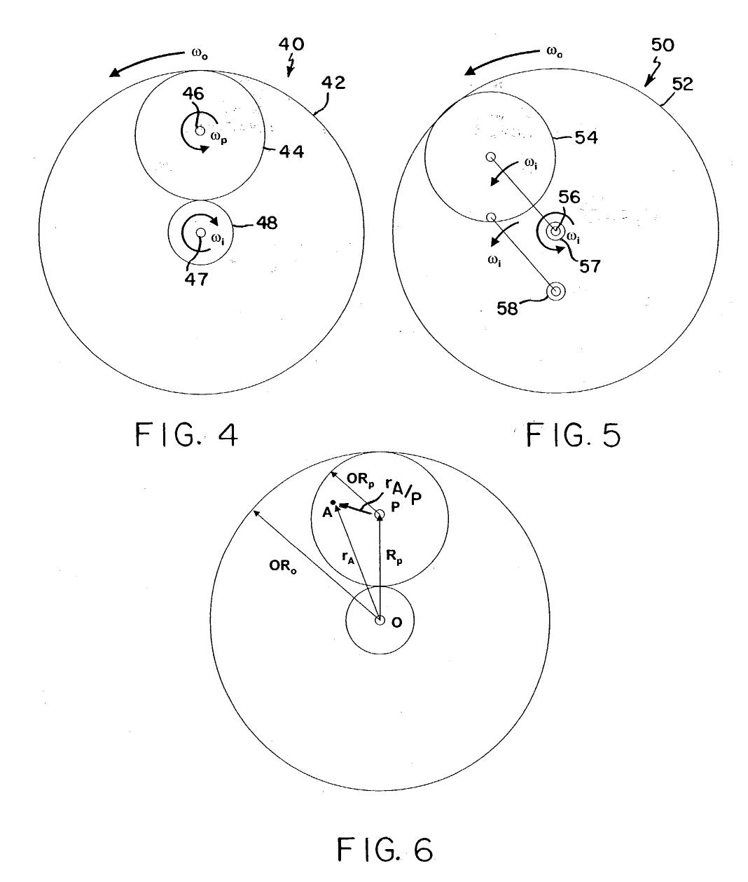

An embodiment of the mechanical operation of the planet(s) 44 of the present invention will now be described referring to FIG. 4. Although, for this discussion and the one to follow, only a single planet 44 is shown confined within the outer ring gear 42 and discussed, the invention is not to be construed as being so limited. Preferably, the CVT 40 includes a plurality of planets, which allows the individual transferred shear loads of each planet to add to the total shear load transmitted.

FIG. 4 shows an epicyclical topology system 40 of planetary motion. The epicyclical topology system 40 shown includes a rotating outer ring 42, e.g., an output shaft (not shown), and a rotating inner component, e.g., planet 44. In the epicyclical planetary system 40 shown, an input gear 47 drives, i.e., provides torque to, the inner planet(s) 44 so that the planet(s) 44 rotate at an angular velocity ωₚ about a fixed point 46 without translation. Rotation of the planet(s) 44, in turn rotate the outer ring 42 at an angular velocity ωₒ.

FIG. 5 shows a hypocyclic topology system 50 of planetary motion. A hypocyclic topology system 50 includes a rotating outer ring 52, e.g., an output shaft, and a rotating inner component, e.g., planet 54. With the hypocyclic system 50, the planet(s) 54 are driven by the input crank 57 and orbit about the center of the outer ring 52, however, they do not rotate. An idler crank 58 prevents rotation of the hypocyclic planet(s) 54.

Referring now to FIG. 6, the relative velocity vector r_{A} of a planet at any point A is the vector difference between the overlying velocity vectors on the planet fin R_{P} and outer ring fin at Point A. Accordingly,

$$\begin{matrix}{V}_{rel} = \{ \begin{matrix}{V}_{A / P} - {V}_{A / O} , & epicyclic \\ {V}_{P / O} - {V}_{A / O} , & hypocyclic\end{matrix} \\ where & ( 3 ) \\ {V}_{A / O} = {ω}_{O} \times {r}_{A} \\ {V}_{A / P} = {ω}_{P} \times {r}_{A / P} ( epicyclic only ) \\ {V}_{P / O} = {ω}_{P} \times {R}_{P} ( hypocyclic only ) & ( 4 )\end{matrix}$$

Furthermore, the shear stress vector τ of a planet at any point is equal to

$$τ = {τ}_{y} \frac{{V}_{rel}}{\vert {V}_{rel} \vert} + β {V}_{rel} \qquad ( 5 )$$

Accordingly, the relative velocity and the shear stress vectors depend upon the location of interest. Moreover, the relative velocity and the shear stress vectors each can produce a vector field when plotted over the activated shear region 11. The activated shear area 11 is defined as that portion of the overlap of the fins of the planet and outer ring where the MR fluid has been activated by the application of a magnetic flux field 19.

The relative velocity vector field associated with the epicyclical planetary model 40 conveys counterclockwise rotation about a synchronous point, which is a unique point within the region of overlap at which relative velocity is equal to zero. The magnitude of the velocity vectors increases linearly at increasing radial distances from the synchronous point. The shear stress field also exhibits a counterclockwise orientation about the synchronous point when applied to the outer ring 42. The magnitude of the shear stress field varies little over the region of overlap, i.e., less than about 2% variation, due to the fact that the viscosity of the MR fluid contributes little to the shear stress and, hence, torque transmission at high yield shear stresses, i.e., high magnetic fields.

For the hypocyclic planetary model 50 the reverse is true. Indeed, the velocity field associated with the hypocyclic planetary model 50 conveys clockwise rotation about a synchronous point. The magnitude of the velocity vectors increases linearly at increasing radial distances from the synchronous point. The shear stress field also exhibits a clockwise orientation about the synchronous point when applied to the outer ring 52. Here again, the magnitude of the shear stress field does not change very much over the region of overlap. As before, the viscosity of the MR fluid itself plays little role in torque transmission at high yield shear stresses, i.e., high magnetic fields.

The location of the synchronous point is of interest because it provides indicia of the speed ratio of the transmission. The speed ratio SR is defined in the following manner:

$$SR = \{ \begin{matrix}\frac{{r}_{SP / O}}{{r}_{SP / P}} \frac{1}{( Fixed Input Gear Ratio )} , ( epicyclic ) \\ \frac{{r}_{SP / O}}{{R}_{P}} , ( hypocyclic )\end{matrix} \qquad ( 6 )$$

where r_{SP/O} and r_{SP/P} are the distances of the synchronous point from the axes of rotation for the outer ring and the planet, respectively.

The synchronous point in either system 40 and 50 moves as the speed ratio changes. An important difference between the epicyclical and hypocyclic systems 40 and 50 is the fact that the synchronous point moves in opposite directions as the speed ratio changes. For example, FIG. 8 shows an exemplary illustration of an efficient yet practical active area 87 for operating the epicyclic version of the transmission 10. The chosen active area shape is bounded by an inner radius 82, an outer radius 84, and two radial boundaries 86 and 88 that form a subtend angle 85. When there is no output torque, the synchronous point 83 is located at some “neutral point”, which is always located within the active region 87. Placing the active area just beyond (or outside) the synchronous point 83 is best for epicyclical systems 40, whereas placing the active area just within or inside the synchronous point 83 is best for hypocyclic systems 50.

Those skilled in the art can calculate the input torque and output torque by integrating the local shear stress over the active area 87. For the epicyclical system 40, the planet 44 torque is calculated instead of the input torque, since an input gear 47 is required. However, the input torque can be obtained by multiplying the planet torque by the fixed input gear ratio.

$${T}_{O} = {\int }_{Area}^{} ( {r}_{A} \times τ ) \cdot k ⅆ A \\ {T}_{P} = {\int }_{Area}^{} ( {r}_{A / P} \times τ ) \cdot k ⅆ A ( epicyclic only ) \\ {T}_{i} = {\int }_{Area}^{} ( {R}_{P} \times τ ) \cdot k ⅆ A ( hypocyclic only ) \qquad ( 7 )$$

Accordingly, the efficiency of the CVT 10 is

$$Efficiency = \{ \begin{matrix}\frac{{T}_{O} {ω}_{o}}{{T}_{p} {ω}_{p}} , ( epicyclic ) \\ \frac{{T}_{O} {ω}_{o}}{{T}_{i} {ω}_{i}} , ( hypocyclic )\end{matrix} \qquad ( 8 )$$

Since equation (7) integrates over the active area 87 only, substitution of the resulting calculated torques in equation (8) considers losses present in the active area 87 only. These losses arise from relative velocities that are not perpendicular to the torque arms of the planet(s) 44 and 54 and the outer ring gear 42 and 52. Accordingly, increasing the active area 83 increases output torque capability and decreases efficiency. Moreover, as the speed ratio increases, the following occurs: (i) the output torque increases; (ii) the efficiency increases from low speed ratios to higher speed ratios as the SP drags the most productive portion of the relative velocity vector field into the active area; (iii) the efficiency peaks and then drops at higher speed ratios, since, as the SP continues to travel with increasing speed ratio, it drags higher magnitude relative velocities into the active area.

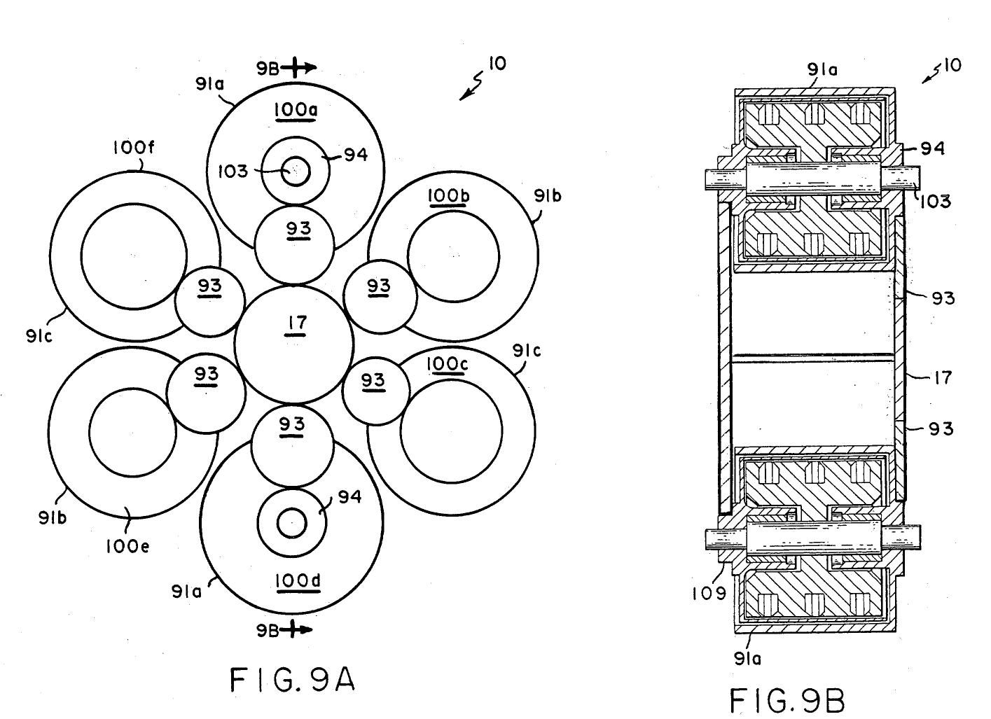

In a preferred embodiment, the CVT transmission 10 comprises a plurality, e.g., six (6), of multiple gear trains 91 that are configured and arranged axially about a common input shaft 17. The plurality of multiple gear trains 91 operates, preferably, with the gear trains operating in parallel and, more preferably, in tandem. For example, FIG. 9A shows a pair of gear trains designated 91a, a pair of gear trains designated 91b and a pair of gear trains designated 91c.

Referring to FIGS. 9A and 9B, there are shown, respectively, elevation and cross-sectional views of an exemplary multiple-gear CVT 10. Although three gear train pairs 91a, 91b, and 91c, wherein each pair comprising two diametrically-opposed clutch assemblies 100, are shown in FIG. 9A, the invention is not to be construed as being so limited. Indeed, CVTs 10 according to this embodiment can include more than or fewer than three pairs gear trains 91a, 91b, and 91c and, further, there is no requirement that the individual clutch assemblies 100 be paired.

Each paired gear train 91a, 91b, and 91c includes a corresponding gear ratio that is determined by the ratio of the pitch diameter of its idler gear 93 to the diameter of the clutch input gear 94. For example, gear trains 91a, 91b, and 91c can provide gear ratios of 4:1, 5:1 and 6:1, respectively. Those skilled in the art can vary the diameters of the idler gears 93 and/or the clutch input gears 94 to provide any desired gear ratio.

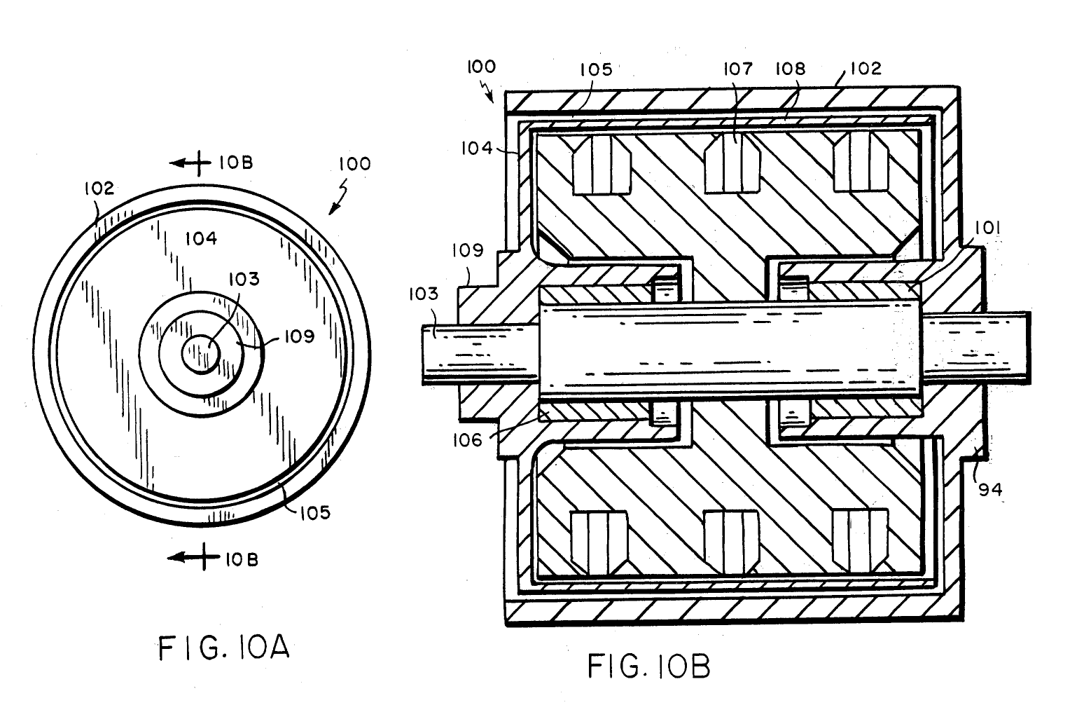

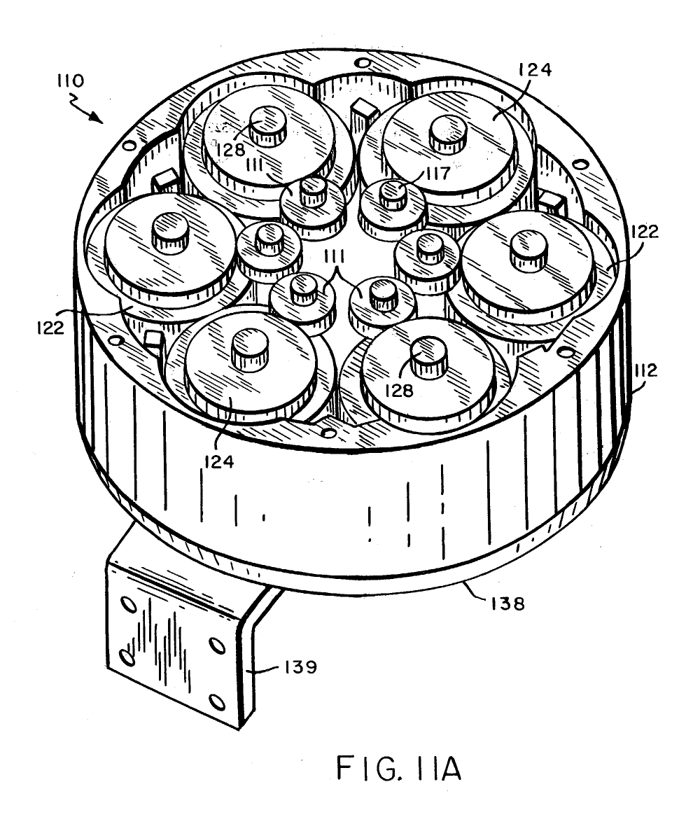

Referring to FIGS. 10A and 10B, a clutch assembly 100 will now be described. Each clutch assembly 100 comprises a plurality of, e.g., two, concentric cylinders, or cups, 102 and 104. An input cup 102, which is in communication with the input gear 94, is attached to a first bearing or bearing assembly 101. The first bearing or bearing assembly 101 is interposed between the input cup 102 and a shaft assembly 103, thereby allowing the input cup 102 to rotatably move about the stationary shaft assembly 103 freely. The input gear 94 can provide torque, e.g., from the idler gear 93, to rotatably move the input cup 102 when power is flowing out of the CVT 10, or accepts torque from the input cup 102 when power is flowing to the CVT 10.

An output cup 104, which is in communication with the output gear 109, is attached to a second bearing or bearing assembly 106. Preferably, the output cup 104 also is disposed inside the input cup 102. The second bearing or bearing assembly 106 is interposed between the stationary shaft 103 and the output cup 104, thereby allowing the output cup 104 to rotatably move about the stationary shaft 103 freely. The output cup 104 can provide torque to rotatably move the output gear 109 when power is flowing out of the CVT 10, or accepts torque from the output gear 109 when power is flowing to the CVT 10.

A small gap 105 separates the input and output cups 102 and 104. Preferably, the gap 105 is filled with an MR fluid of a type described above. When the gap 105 is filled with an MR fluid, one or more clutches 100 can be actuated by applying current to toroidal coils, i.e., a plurality of copper windings, 107 that are wound about a stator 108. The stator 108 is structured and arranged within the inner (output) cylinder 104 and is in tight interference fit with or fixedly attached to the stationary shaft 103. Applying current to the toroidal coils 107 induces a magnetic flux field in the MR fluid in the gap 105 between the input and output cups 102 and 104, which transfers shear force from the outer (input) cylinder 102 to the inner (output) cylinder 104 in a manner previously described. The output cylinder 104 is in communication with an output gear 109, which, in turn, is in communication with an output shaft gear 95, which, in turn, is in communication with the output shaft (not shown).

The operation and interplay of the components of the above-described multiple gear train CVT 10 will now be described. During normal operation, power can be provided to an input shaft 17. The outer periphery of input shaft 17 is in communication with the outer periphery of a plurality of idler gears 93 so that any rotation of the input shaft 17 provides rotation of the plurality of idler gears 93. The outer periphery of each of the plurality of idler gears 93 is also in communication with the outer periphery of a discrete clutch input gear 94 of a plurality of clutch assemblies 100 so that rotation of any of the idler gears 93 provides rotation of the discrete clutch input gears 94 in communication therewith. Each of the clutch input gears 94 is further in communication with an input cylinder 102 of an organic clutch assembly 100 so that rotation of the clutch input gears 94 also provides rotation of the associated input cylinder 102. In short, any rotation of the input shaft 17 provides rotation of each of the input cylinder 102 of each of the plurality of clutch assemblies 100.

A control unit (not shown) controls the delivery of current to the coils 107 of each of the clutch assemblies 100. The control unit can control the amount, or intensity, of the current delivered to the coils 107 as well as the particular coils 107 to which the current is delivered. Only those coils 107 that receive current at any point in time actuate the clutch assembly 100 so that rotation of the input cup 102 can be transferred to the output cup 104 through the activated shear region 11 of the MR fluid. Thus, by controlling the actuation of each of the clutch assemblies 100, each of which can have a unique speed ratio, one can control the speed ratio of the system.

For example, according to the illustrative embodiment depicted in FIGS. 9A and 9B, a CVT 10 can include three gear train pairs 91a, 91b and 91c, which pairs each comprise a pair of diametrically-opposed clutch assemblies 100. A first gear train pair 91a, which includes clutch assemblies 100a and 100d, can be associated with a gear ratio of 4:1. A second gear train pair 91b, which includes clutch assemblies 100b and 100e, can be associated with a gear ratio of 5:1. A third gear train pair 91c, which included clutch assemblies 100c and 100f, can be associated with a gear ration of 6:1. If a gear ratio of 4:1 is desired, the control unit would provide full current to the coils 107 that communicate with gear train pair 91a. No current would be provided to gear trains pairs 91b or 91c. As a result, although torque from the input shaft 17 drives the input cylinders 102 of each gear trains pair 91a, 91b, and 91c, only the MR fluid disposed in the gap 105 of gear train pair 91a is actuated to provide an active shear region. Indeed, because the MR fluid in the gap 105 of gear train pair 91a is actuated, torque from the input cylinder 102 can be transferred by shear to the output cylinder 104 of gear train 91a, which, by design, provides a 4:1 speed ratio. Because there is no current to gear train pairs 91b or 91c, there is no activated shear region and rotation of the input cylinder 102 of each of gear trains pairs 91b and 91c does not provide shear to the associated output cylinders 104. Similarly, if a gear ratio of 5:1 were desired, full current would only be provided to the coils 107 of gear train pair 91b and if a gear ratio of 6:1 were desired, full current would only be provided to the coils 107 of gear train pair 91c.

The embodied CVT 10 can provide a variable speed ratio intermediate between about 4:1 and about 6:1 by causing one or more gear train pairs 91a, 91b or 91c to slip. Slippage provides a reduced speed ratio. Hence, for example, by reducing the current and thereby the intensity of the magnetic flux field to a particular clutch assembly 100, less shear is transferable from the input cup 102 to the output cup 104. Thus, the output cylinder 104 realizes a slip, or reduction in relative speed, with respect to the input cylinder 102. Alternatively, in another aspect of the present invention, the control unit can deliver the same current intensity to less than all of the coils 107. By illustrative example, FIGS. 9B and 10B show three coils 107. Current can be provided only to the two outer coils 107 or to just the inner coil 107 to provide slippage caused by reduced shear transfer. Thus, if a gear ratio of 4.6:1 is desired, the current to the coils 107 to gear train pair 91b, which has a speed ration of 5:1 can be reduced. Controlling the current to the coils 107, reduces the magnitude, or intensity, of the magnetic flux field that provides an activated shear region in the MR fluid between the input and output cups 102 and 104 of the gear train pair 91b.

However, when delivering power to, e.g., a vehicle wheel or other load, only those gear trains 91 with gear ratios below the desired output gear ratio, i.e., 4:1, 3:1, etc., can contribute to mechanical power transmission. Gear ratios greater than the desired gear ratio, e.g., 5:1, 6:1, etc., cannot contribute to mechanical power transmission because the input cylinders 102 of the gear train 91 will be rotating more slowly than output speed would dictate. Thus, for the illustrative example, the clutches 100a and 100b corresponding to a 4:1 gear ratio can be made to slip by about 13 percent, i.e, (4.6-4.0)/4.6, to provide the desired gear ratio. In so doing, the percent slip required to reach a desired gear ratio is more modest than that of the prior art, which minimizes the amount of power lost, e.g., 13 percent, due to the slip.

When, however, delivering power from, e.g., a vehicle wheel or other load, to the gear trains 91, as happens, e.g., while descending an incline, only those gear trains 91 with gear ratios above the desired output gear ratio, i.e., 5:1, 6:1, etc., can contribute to mechanical power transmission, which, in effect, uses the engine's momentum to prevent the motor vehicle from freely accelerating. Gear ratios less than the desired gear ratio, e.g., 4:1, 3:1, etc., cannot contribute to mechanical power transmission because the input cylinders 102 of the gear train 91 will be rotating more rapidly than output speed would dictate.

In a fourth embodiment, MR-type clutch assemblies 100 can be replaced with oil shear clutch assemblies, which transfer shear from input to output drive components through viscous forces developed by the shear of the oil in the gap and/or by direct transferal between the two drive components.

Oil shear clutches use oil to transmit torque between two surfaces in a similar manner as the first embodiment uses magnetorheological fluid. An oil shear clutch comprises a first, input device usually having a plurality of keyed discs that are separated from a second, output device having a corresponding plurality of keyed discs. A thin film of oil circulates between the keyed discs of the first and the second devices such that the thin film of oil moves at virtually the same velocity as the first, input device. As the thin film moves, it overcomes viscous forces whereby torque can be transmitted between the keyed discs through the shearing of the oil. At synchronous speed, an external pressure can be added so that the discs of the input and output drive components physically contact one another and the torque provided by the input device drives the output device directly. Typically, compressed air, hydraulic fluids or springs are used to effect the physical contact between the two devices on demand.

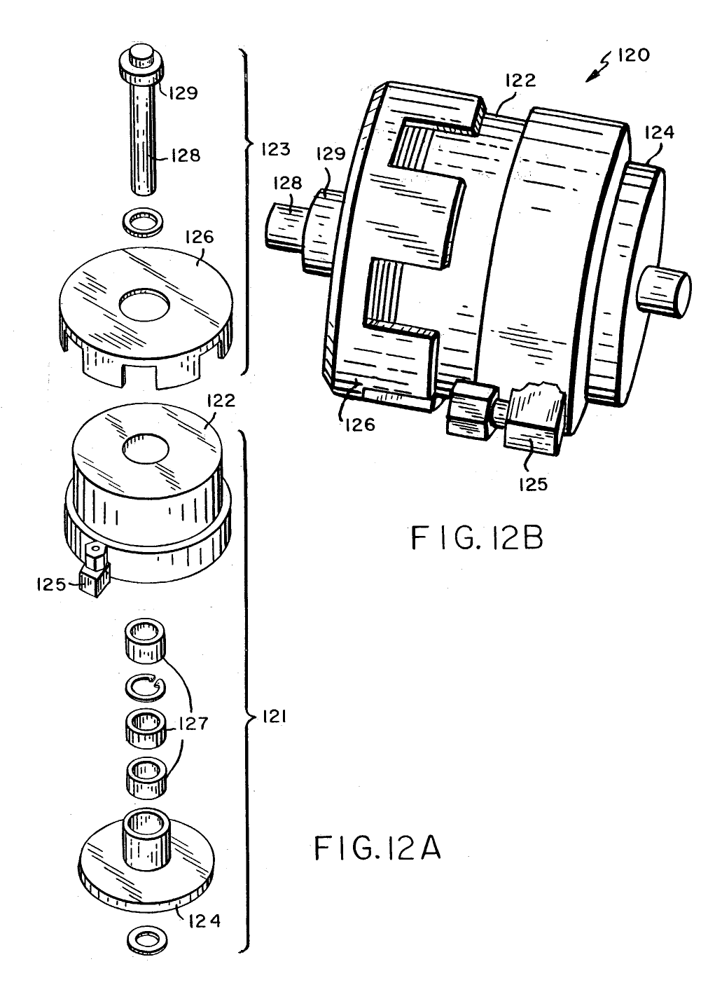

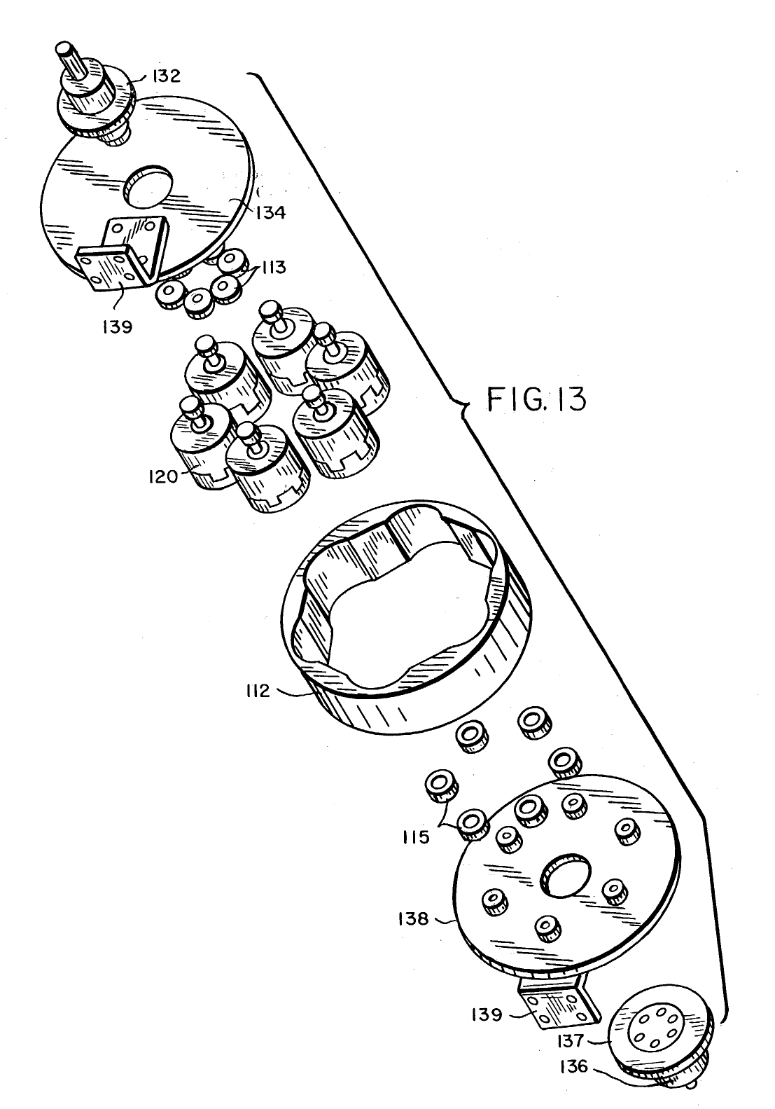

An exploded view and a diagrammatic view of an exemplary oil shear clutch 120 are shown in FIGS. 12A and 12B, respectively. Oil shear clutches 120 are commercially available and well-known to the art. Briefly, an oil shear clutch 120 comprises an input drive component 121 and an output drive component 123. The input drive component 121 comprises an input clutch gear 124 and a keyed clutch cylinder 122. The input clutch gear 124 is in direct communication, e.g., in tight interference fit, press fit, adhesively attached, and the like, with the clutch cylinder 122 so that the clutch cylinder 122 rotates synchronously with the input clutch gear 124. A circular annulus 127 for receiving an output shaft 128 is provided through the center of the clutch cylinder 122 and the input clutch gear 124. One or more bearing assemblies 127 are interposed, e.g., tight interference fit, press fit, adhesively attached, and the like, between the inner surface of the input clutch gear 124 and the output shaft 128 so that rotation of the input clutch gear 124 and clutch cylinder 122 does not produce any unwanted rotation of the output shaft 128, and vice versa.

The clutch cylinder 122 includes a plurality of keyed discs that are structured and arranged in an engagement area. A clutch inlet port 125 through which, e.g., compressed air or hydraulic fluid can be introduced into the cylinder 122 to actuate the output drive component 123 and/or to induce slippage communicates with the clutch cylinder 122.

The output drive component 123 comprises a drive cup and hub assembly 126 and a, e.g., steel, output shaft 128. The drive cup and hub assembly 126 also includes a plurality of keyed discs (not shown) that are structured and arranged so that the keyed discs of the drive cup and hub assembly 126 can be interposed between the keyed discs of the clutch cylinder 122. The output shaft 126 is in direct communication, e.g., by tight interference fit, press it, adhesively attached, and the like, with the drive cup and hub assembly 126 so that rotation of the drive cup and hub assembly 126 provides synchronous rotation of the output shaft 128, and vice versa. The output shaft 128 includes an integral output gear 129 or, alternatively, is in direct communication with an output gear 129 that is structured and arranged to rotate synchronously with the output shaft 128 and the drive cup and hub assembly 126.

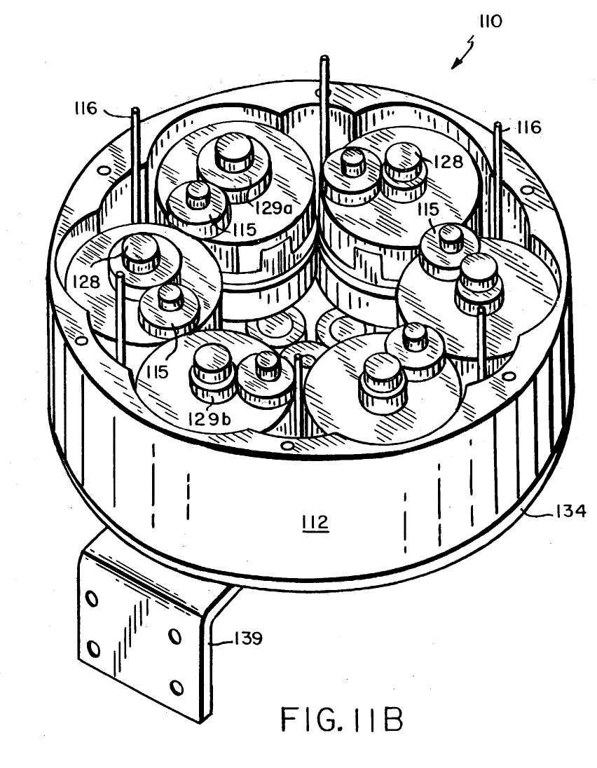

Referring to FIGS. 11A and 13, the input operation of an in-wheel transmission 110 will now be described. In FIGS. 11A and 13, there are shown a plurality, e.g., six, of oil shear clutch assemblies 120 that are arranged symmetrical about a housing body 112. Although, it should be noted that the number of clutch assemblies 120 shown can vary and the invention is not to be construed as being limited to only six clutch assemblies 120. More or fewer clutch assemblies 120 can be used without violating the scope and spirit of this disclosure. Preferably, the housing body 112 is fabricated from a metal, a metal alloy or a durable carbon-carbon composite. More preferably, the housing body 112 is fabricated from aluminum, e.g., 6061-T6 aluminum. A pair of housing covers 134 and 138 is releasably attachable, e.g., using bolts, screws, clamps, and the like, to the input side and output side of the housing body 112. Preferably, the pair of housing covers 134 and 138 is fabricated from a metal, metal alloy or a durable carbon-carbon composite. More preferably, the pair of housing covers 134 and 138 is fabricated from aluminum, e.g., 6061-T6 aluminum. A mounting bracket 139 is releasably attached, e.g., using screws, bolts, clamps, and the like, to at least one of the housing covers 134 and 138 to releasably or fixedly attach the CVT 10 to the vehicle. Preferably, the mounting brackets 139 are fabricated from metal or metal alloy. More preferably, the mounting brackets are fabricated from steel, e.g., an A36 steel angle. In a particular embodiment, the outer diameter of the aluminum body 112 is about 10.38 inches and the housing body 112 with both housing covers 134 and 138 attached is about 4.4 inches.

The input clutch gears 124 of each of the plurality of clutch assemblies 120, each input clutch gear 124 having substantially the same diameter, are each is in communication with a discrete input idler assembly 113. Preferably, the input idler assemblies 113 comprise a rotatable idler gear 111, a stationary idler shaft 117 about which the idler gear 111 can rotate, and a roller bearing (not shown) that allows the idler gear 111 to rotate about the idler shaft 117 freely. Preferably, the idler gear 111 and idler shaft 117 are fabricated from metal or metal alloy. More preferably, the idler gear 111 and idler shaft 117 are fabricated from steel, e.g., AISI 8620 steel.

The roller bearing is disposed, e.g., in tight interference fit, press fit, adhesively attached, and the like, to the inner periphery of the idler gear 111, interposed between the idler gear 111 and the idler shaft 117, enabling the idler gear 111 to rotate without rotation of the idler shaft 117.

The outer periphery of the idler gears 111 of each of the input idler assemblies 113 can be in direct communication with the outer periphery of the rotatable shaft of an input shaft assembly 132. The outer peripheries of the idler gears 111 further can be in communication with the outer peripheries of the input clutch gear 124 of a plurality of discrete clutch assembly 120. Accordingly, the rotatable shaft of the input shaft assembly 132 can provide torque, i.e., drive, successively the plurality of input idler assemblies 113, the discrete input clutch gears 124 in communication with those input idler assemblies 113, and the clutch cylinders 122 in communication with those input clutch gears 124.

Referring now to FIGS. 11B and 13, the output operation of an in-wheel transmission 110 will now be described. Shown illustratively is a plurality, e.g., six, output drive components 121 corresponding to the same plurality of clutch assemblies 120 described above. Here again, the invention is not to be construed as being limited to six clutch assemblies. More or fewer clutch assemblies 120 can be used without violating the scope and spirit of this disclosure. The output drive components 121 comprise an output shaft 128 having or in communication with an output gear 129 and a drive cup and hub assembly 126, which, as previously described, can rotate synchronously as a single unit. Preferably, the diameters of the output gears 129 of the plurality of clutch assemblies 120 vary to provide a plurality of speed ratios. However, it is more preferable that at least one pair of diametrically-opposed clutch assemblies 120 have the same speed ratio corresponding to the lowest speed ratio to provide greater initial torque to overcome an at-rest condition. Typically, larger diameter output gears 129a provide a lower speed ratio than smaller diameter gears 129.

The outer periphery of each of the output gears 129 of the plurality of clutch assemblies 120 is in communication with the outer periphery of a discrete output idler assembly 115, which assemblies 115 are of like construction as the input idler assemblies 113 described above. Because the diameters of the output gears 129 are not uniform, the output idler assemblies 115, which are configured and arranged with a common diameter, are disposed asymmetrically about the housing assembly 112 so that the outer periphery of the idler gear 111 of each output idler assembly 115 is in direct communication with the outer periphery of the output gear 137 of the output shaft assembly 136.

A control system (not shown) controls the actuation of one or more of the clutch assemblies 120. Preferably, hydraulic pressure, air pressure, and the like can be delivered to the clutch assemblies 120 through a plurality of inlet tubes 116. The added pressure promotes the physical contact between the aforementioned keyed-discs, resulting in the transfer of torque from the clutch cylinder 122 to the drive cup and hub assembly 126. Torque is successively transferred to the output shaft 128 and output gear 129, the output idler assembly 115, the output gear 137, and the output shaft assembly 136. Thus, when a specific transmission ratio is desired, the hydraulic pressure, air pressure or the like to each of the clutch assemblies 120 can be adjusted so that only the keyed discs of the clutch cylinder 122 and the drive cup and hub assembly 126 corresponding to that speed ratio are made to contact one another.

To provide intermediate speed ratios, the control device also can control the slippage of the clutch assemblies 120. Slippage provides an intentional loss of efficiency of the clutch assembly 120, which provides intermediate gear ratios that can produce a continuous variable transmission. Slip can be controlled by modifying the distance between or the contact pressure on the keyed discs of the clutch cylinder 122 and the drive cup and hub assembly 126. For example, hydraulic or pneumatic actuators can be used to control the separation distance or normal force on the keyed discs of the clutch cylinder 122 and the drive cup and hub assembly 126. The greater the distance separating the keyed discs of the clutch cylinder 122 and the drive cup and hub assembly 126 or the smaller the normal force on the keyed discs, the greater the slip and vice versa.

In one embodiment, the in-wheel transmission provides symmetrical pairs of clutch assemblies 120 that are structured and arrange diametrically opposed to one another. More preferably, however, the in-wheel transmission includes a plurality of clutch assemblies 120 having different speed ratios with only the lowest speed ratio associated with a pair of clutch assemblies 120 for providing power to start the vehicle from an at-rest condition.

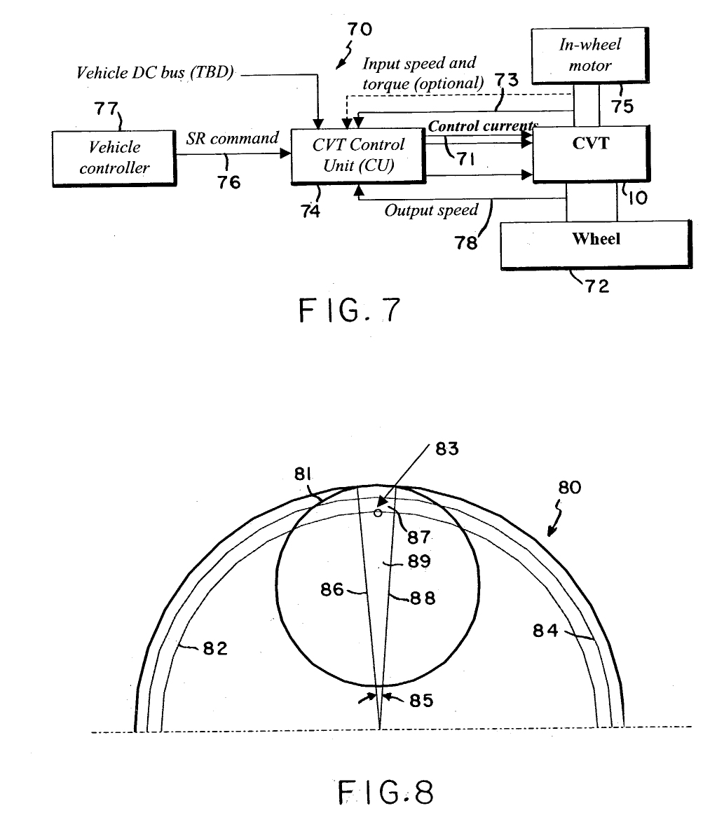

Having described several embodiments of a highly efficient CVT 10 device, a system using that device as applied to an in-wheel motor-transmission assembly 70 will now be described referring to FIG. 7. In a preferred embodiment, the system 70 comprises an in-wheel CVT 10 that will fit within the confines of the motor vehicle wheel 72, e.g., about a 10- to 11-inch diameter and an about 4- to about 5-inch axial length, and that includes the necessary electrical power and signal connections, mounting features, thermal management, coolant connections, and MR fluid port. The system 70 further comprises a separate CVT control unit (CU) 74 to control the speed reduction of the CVT 10, several embodiments of which have been described above. Preferably, speed reduction can be based on the commanded speed reduction 76 from the vehicle controller 77 and measured output speed 78 from the wheel 72. In a separate embodiment, speed reduction also can be based on input speed and/or torque 73 of the in-wheel motor 75. In operation, according to one embodiment, the CVT control unit 74, which comprises a microprocessor with memory, controllers, and power amplifiers, provides control current 71 either to position the magnetic device (not shown) in the CVT 10 so that the magnetic flux field and accompanying activated area provide the desired speed reduction or to actuate one or more discrete clutch assemblies 110. According to a second embodiment, the CVT control unit 74 provides external, e.g., hydraulic, air, and the like, control pressure to one or more clutch cylinders 122 to provide physical contact between input and output elements.

A method of providing a continuously variable speed ratio using an MR fluid will now be described. The method comprises the step of structuring and arranging at least one inner rotating gear or planet and an outer ring gear that are aligned in the same axis to provide a space or gap therebetween. As described previously above, the shape of the planet(s) and outer ring gear, preferably, is conical or cylindrical. Furthermore, preferably, a plurality of plates or fins can be structured and arranged on and substantially orthogonal to the axes of the planet(s) and outer ring gear. Preferably, adjacent plates or fins disposed on the planet(s) do not interfere with or contact the plates or fins disposed on the outer ring gear. Preferably, plates or fins on both the planet(s) and outer ring gear are disposed a uniform distance from adjacent plates or fins on the same host.

The method further comprises the steps of introducing an MR fluid into the space or gap between the planet(s) and outer ring gear; providing a moveable magnetic device to induce a magnetic flux field at any desired location within the space or gap in order to activate the MR fluid in the activated area; and transferring shear stress from the planet(s) to the outer ring gear through the MR fluid activated area. As an alternative to inducing a magnetic field using a moveable magnetic device, the method can include, instead, the steps of actuating one or more clutch assemblies using a current-carrying coil to provide an activated shear region in one or more of the clutch assemblies.

The present invention has been described in detail including the preferred embodiments thereof. However, it should be appreciated that those skilled in the art, upon consideration of the present disclosure, can make modifications and/or improvements of this invention that are within the scope and spirit of this invention as set forth in the following claims.

For example, although the invention has been described for a preferred use with an in-wheel application, the invention is not to be construed as being so limiting. Indeed, the CVT 10 can also be structured and arranged to control the speed reduction of the main rotor of a helicopter during high-speed forward flight. Similarly, the CVT 10 can be structured and arranged to provide a variable speed drive for pumps, fans, and the like with a fixed speed induction motor as the prime mover, eliminating the cost of variable frequency electronics associated with variable speed motors.

What I claim is:

1. A continuously variable speed ratio transmission for providing input torque to an output shaft, the transmission comprising:
an internal drive element movable about an axis, the internal drive elements further comprising one or more planets, said internal drive element being in communication with a device for providing said input torque;
an external drive element movable about an axis, said external drive element being in communication with the output shaft to provide torque to said output shaft,
wherein said internal drive element and said external drive element are structured and arranged to provide a gap therebetween and, further, so that their axes are substantially parallel;
magnetorheological fluid that is disposed in said gap between said internal drive element and said external drive element; and
a magnetic flux producing device, wherein said magnetic flux producing device is moveable with respect to said axes.

2. The transmission as recited in claim 1, wherein each of said one or more planets and said external drive element have a shape that is substantially conical.

3. The transmission as recited in claim 1, wherein each of said one or more planets and said external drive element have a shape that is substantially cylindrical.

4. The transmission as recited in claim 1, wherein each of said one or more planets includes a first plurality of fins structured and arranged thereon and said external drive element includes a second plurality of fins structured and arranged thereon, wherein said second plurality of fins is disposed relative to said first plurality of fins to produce the gap.

5. The transmission as recited in claim 1, wherein the magnetorheological fluid contains solid, ferrous particles.

6. The transmission as recited in claim 5, wherein the magnetorheological fluid is selected from the group comprising silicone, mineral oil, and base oil.

7. The transmission as recited in claim 1, wherein the magnetic flux producing device is selected from the group comprising an induction coil, a permanent magnet, and an electromagnet.

8. The transmission as recited in claim 1, wherein the magnetic flux producing device is movable in at least one of an axial direction and a radial direction with respect to the axes.

9. The transmission as recited in claim 4, wherein the magnetorheological fluid is further disposed between the first and second plurality of fins.

10. The transmission as recited in claim 1, wherein torque is transferred from the device for providing input torque to the output shaft by positioning the moveable magnetic flux producing device at a discrete location and actuating the magnetorheological fluid in proximity of the moveable magnetic flux producing device by passing current through the moveable magnetic flux producing device so as to produce a magnetic flux field that increases the density of said magnetorheological fluid in the magnetic flux field thereby transferring the torque from the device for providing input torque to the output shaft by shear through said densified magnetorheological fluid.

11. A system for providing continuous variable transmission for an in-wheel motor vehicle, wherein the system comprises:
an in-wheel motor that provides an input speed and an input torque;
a continuous variable speed ratio transmission comprising a magnetorheological fluid and a moveable magnetic flux producing device, wherein said continuous variable speed ratio transmission transfers the input torque from the in-wheel motor through said magnetorheological fluid to an output shaft to drive a motor vehicle wheel by shear; and
a continuous variable transmission control unit that provides a control current to position the moveable magnetic flux producing device at a desired location, wherein said moveable magnetic flux producing device provides a magnetic flux field in the magnetorheological fluid at the desired location that provides a shear region in said magnetorheological fluid at said desired location through which the input torque is transferred.

12. The system as recited in claim 11, wherein the continuous variable speed ratio transmission further comprises:
an internal drive element movable about an axis, the internal drive elements further comprising one or more planets, said internal drive element being in communication with a device for providing said input torque; and
an external drive element movable about an axis, said external drive element being in communication with the output shaft to provide torque to said output shaft,
wherein said internal drive element and said external drive element are structured and arranged to provide a gap therebetween and, further, so that their axes are substantially parallel.

13. The system as recited in claim 12, wherein each of said one or more planets and said external drive element has a shape that is selected from a group comprising substantially conical and substantially cylindrical.

14. The system as recited in claim 12, wherein each of said one or more planets includes a first plurality of fins structured and arranged thereon and said external drive element includes a second plurality of fins structured and arranged thereon, wherein said second plurality of fins is disposed relative to said first plurality of fins to produce the gap.

15. The system as recited in claim 11, wherein the magnetorheological fluid contains solid, ferrous particles.

16. The system as recited in claim 15, wherein the magnetorheological fluid is selected from the group comprising silicone, mineral oil, and base oil.

17. The system as recited in claim 11, wherein the magnetic flux producing device is selected from the group comprising an induction coil, a permanent magnet, and an electromagnet.

18. The system as recited in claim 12, wherein the magnetic flux producing device is movable in at least one of an axial direction and a radial direction with respect to the axes.

19. The system as recited in claim 14, wherein the magnetorheological fluid is further disposed between the first and second plurality of fins.

20. A continuously variable speed ratio transmission for providing input torque to an output shaft, the transmission comprising:
an input drive element further comprising an input shaft, said input drive element being in communication with a device for providing said input torque;
a first plurality of idler assemblies that are in communication with the input shaft of the input drive element, whereby input torque provided by said input shaft is transmitted to each of said first plurality of idler assemblies;
one or more magnetorheological clutch assemblies, each of the one or more magnetorheological clutch assemblies having a speed ration and further comprising:
an input cylinder that is rotatable about a stationary shaft;
a clutch input gear, an outer periphery of which is in communication with an outer periphery of one of the first plurality of idler assemblies and the input cylinder so that the clutch input gear, one of the first plurality of idler assemblies and said input cylinder can rotate synchronously; and
a output cylinder which is in communication with an output gear so that the output cylinder and output gear can rotate synchronously,
wherein the output cylinder is coaxial with the input cylinder and separated therefrom by a fluid filled-gap;
a second plurality of idler assemblies, wherein each of said second plurality of idler assemblies is in communication with a discrete output gear of the output cylinder of one of the one or more magnetorheological clutch assemblies, whereby torque transmitted to the output gear of said one or more magnetorheological clutch assemblies is further transmitted to each of said second plurality of idler assemblies; and
an output shaft assembly further comprising:
an output shaft;
an output gear, an outer periphery of which is in communication with each of the second plurality of idler assemblies and the output shaft,
whereby any torque transmitted to said second plurality of idler assemblies is further transmitted to said output shaft assembly output gear and then to the output shaft of the output shaft assembly.

21. The transmission as recited in claim 20, wherein the transmission further comprises:
a housing assembly, the housing assembly further comprising:
a housing body, wherein the housing body is structured and arranged to accommodate the one or more magnetorheological clutch assemblies;
a first housing cover having an opening, wherein the input drive element is structured and arranged so that the said input drive element is releasably attached to an out surface of the first housing cover and the input shaft of said input drive element is disposed through the opening; and
a second housing cover having an opening, wherein the output shaft assembly is structured and arranged so that the output shaft assembly is releasably attached to an outer surface of the second housing cover; the output gear of said output shaft assembly is disposed through the opening.

22. The transmission as recited in claim 21, wherein the first housing cover further includes a plurality of holes for releasably attaching the first plurality of idler assemblies to an inner surface of said first housing cover.

23. The transmission as recited in claim 21, wherein the second housing cover further includes a plurality of holes for releasably attaching the second plurality of idler assemblies to an inner surface of said second housing cover.

24. The transmission as recited in claim 21, wherein the transmission further includes one or more mounting brackets that are releasably attachable to at least one of the outer surfaces of the housing covers to releasably secure the transmission and to prevent vibrations.

25. The transmission as recited in claim 20, wherein each of the one or more magnetorheological clutch assemblies further comprises one or more current-carrying coil windings through which current can be transmitted to induce a magnetic flux field in a magnetorheoloigcal fluid disposed in the fluid-filled gap.

26. The transmission as recited in claim 25, wherein the transmission can provide a desired speed ratio by transmitting current to one or more magnetorheological clutch assemblies that have the desired speed ratio.

27. The transmission as recited in claim 20, wherein the speed ratio of each of the one or more magnetorheological clutch assemblies is unique.

28. The transmission as recited in claim 20, wherein the one or more magnetorheological clutch assemblies comprises pairs of diametrically opposed clutch assemblies that have the same speed ratio.

29. The transmission as recited in claim 20, wherein the one or more magnetorheological clutch assemblies comprises six clutch assemblies.

30. A method of providing a continuously variable speed ratio in a transmission, the transmission, the method comprises the steps of:
providing an outer ring gear;
providing at least one inner rotating gear that is disposed inside the outer ring gear;
structuring and arranging the at least one inner rotating gear and the outer ring gear so they are aligned in parallel axes and to provide a space or gap therebetween;
introducing a magentorheological fluid into said space or gap between said at least one inner rotating gear and said outer ring gear;
providing a moveable magnetic flux producing device to induce a magnetic flux field at a desired location within said space or gap in order to activate the magnetorheological fluid at the desired location; and
transferring torque from the at least one inner rotating gear to the outer ring gear as shear stress in the magnetorheological fluid in the desired location to provide a desired speed ratio.

31. The method as recited in claim 30, wherein the step of providing a moveable magnetic flux producing device comprises providing a moveable magnetic flux producing device that translates in at least one of a substantially axial direction and a substantially radial direction with respect to the parallel axes.

32. The method as recited in claim 30, wherein the step of transferring torque from said at least one inner rotating gear to said outer ring gear is transferred through the magnetorheological fluid that is disposed between a first plurality of fins disposed on said at least one inner rotating gear and a second plurality of fins disposed on said outer ring gear.

33. The method as recited in claim 30, wherein the method further comprises the step of controlling the desired speed ratio.

34. The method as recited in claim 33, wherein the step of controlling the desired speed ratio comprises controlling current intensity to the moveable magnetic device.

35. A continuously variable speed ratio transmission for providing input torque to an output shaft, the transmission comprising:
an input drive element further comprising an input shaft, said input drive element being in communication with a device for providing said input torque;
a first plurality of idler assemblies that are in communication with the input shaft of the input drive element, whereby input torque provided by said input shaft is transmitted to each of said first plurality of idler assemblies;
one or more clutch assemblies, each of said one or more clutch assemblies having a speed ratio, wherein each of said one or more clutch assemblies comprises:
an input clutch gear of the same diameter, and
an output clutch gear having a diameter that affects the speed ratio,
whereby any torque transmitted to the input clutch gear of each of said one or more clutch assemblies by said first plurality of idler assemblies is further transmitted to the output clutch gear of each of said one or more clutch assemblies;
a second plurality of idler assemblies, wherein each of said second plurality of idler assemblies is in communication with the output clutch gear of said one or more clutch assemblies, whereby any torque transmitted to each output gear of said one or more clutch assemblies by said first plurality of idler assemblies is further transmitted to each of said second plurality of idler assemblies; and
an output shaft assembly further comprising:
an output gear that is in communication with each of said second plurality of idler assemblies, and
an output shaft that is in communication with said output shaft assembly output gear,
whereby any torque transmitted to the second plurality of idler assemblies is further transmitted to said output shaft assembly output gear and then to the output shaft of the output shaft assembly.

36. The transmission as recited in claim 35, wherein the transmission further comprises a housing assembly, the housing assembly further comprising:
a housing body, wherein the housing body is structured and arranged to accommodate the one or more clutch assemblies;
a first housing cover having an opening, wherein the input drive element is structured and arranged so that the said input drive element is releasably attached to an out surface of the first housing cover and the input shaft of said input drive element is disposed through the opening; and
a second housing cover having an opening and a plurality of inlet tube openings, wherein the output shaft assembly is structured and arranged so that the output shaft assembly is releasably attached to an outer surface of the second housing cover; the output gear of said output shaft assembly is disposed through the opening; and each inlet tube of said plurality of inlet tubes is in communication with a clutch inlet port on each of said one or more clutch assemblies for the purpose of controlling the speed ratio of the transmission.

37. The transmission as recited in claim 36, wherein the first housing cover further includes a plurality of holes for releasably attaching the first plurality of idler assemblies to an inner surface of said first housing cover.

38. The transmission as recited in claim 36, wherein the second housing cover further includes a plurality of holes for releasably attaching the second plurality of idler assemblies to an inner surface of said second housing cover.

39. The transmission as recited in claim 36, wherein the transmission further includes one or more mounting brackets that are releasably attachable to at least one of the outer surfaces of the housing covers to releasably secure the transmission and to prevent vibrations.

40. The transmission as recited in claim 35, wherein each of the one or more clutch assemblies further comprises a clutch inlet tube for actuating one or more of said one or more clutch assemblies to provide a desired speed ratio to the output shaft.

41. The transmission as recited in claim 35, wherein said one or more clutch assemblies are oil shear-type clutch assemblies.

42. The transmission as recited in claim 35, wherein the diameter of the output clutch gear of at least two diametrically opposed clutch assemblies is the same.

43. The transmission as recited in claim 35, wherein the one or more clutch assemblies comprises six clutch assemblies.

44. A system for providing continuous variable transmission for an in-wheel motor vehicle, wherein the system comprises:
an in-wheel motor that provides an input speed and an input torque;
a continuous variable speed ratio transmission comprising one or more oil shear-type clutch assemblies, wherein each of the one or more oil shear-type clutch assemblies has a speed ratio; and
a continuous variable transmission control unit that provides external pressure to actuate one or more of the one or more oil shear-type clutch assemblies to provide a desired speed ratio, whereby actuation can be effected by applying said external pressure to one or more of said one or more oil shear-type clutch assemblies that have the desired speed ratio.
